(19) United States
(12) Patent Application Publication
(10) Pub. No.: US 2012/0084123 A1
(43) Pub. Date: Apr. 5, 2012

(54) INTERACTIVE COMPUTER MOUSE

(76) Inventor: Nick Pajic, Phoenix, AZ (US)

(21) Appl. No.: 12/897,598

(22) Filed: Oct. 4, 2010

(51) Int. Cl. G06Q 30/00; G06F 3/033

(52) U.S. Cl. 705/14.4; 345/163

(57) ABSTRACT

An interactive computer mouse is configured to provide one or more interactive features that take advantage of the close proximity of the mouse to its users. The mouse may comprise one or more mouse buttons and a motion sensor. The mouse may also have a housing that is formed with a display. The display may be used to present information such as advertising or other marketing information on the mouse and be configured to conform to a mouse's curved, ergonomic, or other shape. A launch button, one or more sensors, or both may be configured to signal the mouse to display marketing information on the display. The mouse may include a memory device for synchronizing a user's data files.

### BACKGROUND OF THE INVENTION

1. Field of the Invention

The invention relates to input devices for computing devices and particularly to an interactive computer mouse.

2. Related Art

Computer mice are used as pointing devices to move an onscreen cursor. This allows a computer user to navigate windows or various other user interface elements on the user's computer. Computer mice typically include a left and right mouse button that accepts user input in the form of a button press or click. This input is also used to navigate user interface elements on the user's computer.

A computer mouse is typically conveniently located within the user's grasp. Though some computer mice may provide haptic feedback, a traditional mouse otherwise only allows the user input described above. From the discussion that follows, it will become apparent that the present invention addresses the deficiencies associated with the prior art while providing numerous additional advantages and benefits not contemplated or possible with prior art constructions.

### SUMMARY OF THE INVENTION

An interactive computer mouse is disclosed herein. In general, the mouse provides one or more interactive features that take advantage of the close proximity of the mouse to its users. The mouse may be used as a vehicle for distributing advertising or other marketing information. As such, the mouse may include specialized inputs that may be inalterably configured to display marketing information stored locally or remotely. The mouse may include a display to present such marketing information, and users may interact with such information using the mouse, as will be described herein.

In one exemplary embodiment, an interactive computer mouse may comprise one or more mouse buttons, a housing, and a base below the housing. A launch button may also be included. When activated, the launch button may cause a webpage or website to be displayed to the user. The launch button may comprise the housing and one or more actuating mechanisms located at the base. The launch button may be configured to move between a first position where the housing is a first distance from the base and a second position where the housing is a second distance from the base. At the second position the launch button may cause one or more predefined operations to be carried out, such as the display of various information on the display skin or on the host computer.

One or more memory devices may be within the housing. The one or more memory devices may be configured to store user data such as text documents, images, video files, and audio files. A transceiver configured to receive the user data for storage on the one or more memory devices and to transmit the user data to a host computer may also be included.

The interactive computer mouse may have various other input/output components. The mouse may comprise one or more sensors such as a microphone or a camera. These sensors may be used to capture input from a user or the environment. Alternatively, or in addition, the mouse may comprise one or more output devices such as a speaker or a vibration generator. These devices may be used to provide output of feedback to a user. The mouse may comprise one or more touch sensors beneath the display skin as well. The one or more touch sensors may be configured to detect contact with a user at one or more locations of the display skin.

In another exemplary embodiment, a pointing device distributed by a promoter for use with a host computer may be provided. The pointing device may comprise a housing having a shape. The housing itself may comprise a display skin configured to conform to the shape and to display information visually at a front, back, top, and side of the housing. The display skin may have a curved shape, may form at least 30% of the housing's exterior surface, or both. It is noted that at least two display skins may form the housing. The mouse may include one or more mouse buttons configured to capture one or more user input, and at least one motion sensor configured to detect the motion of the pointing device.

A controller may be configured to receive marketing information from the promoter and display the marketing information on the display skin. A launch button configured to signal the controller to display the marketing information on the display skin may be provided as well. The launch button may comprise the housing and one or more actuating mechanisms located at the base. The launch button may be configured to move between a first position where the housing is a first distance from the base and a second position where the housing is a second distance from the base.

Holding the launch button in the second position for a first period of time may signal the controller to display a first subset of the marketing information on the display skin. Holding the launch button in the second position for a second period of time may signal the controller to display a second randomly selected subset of the marketing information.

A memory device having the marketing information from the promoter fixed thereon may be included. The controller may receive the marketing information from this memory device. The marketing information may comprise a promotion selected from the group consisting of advertising for the promoter's brand, one or more goods offered by the promoter, and one or more services offered by the promoter.

In yet another exemplary embodiment, a method for presenting one or more interactive features on a computer mouse is provided. The method may comprise connecting the computer mouse to a host computer, moving the computer mouse and pressing one or more mouse buttons to control the host computer, accepting marketing information from one or more promoters, and storing the marketing information on one or more storage devices. It is noted that user data may also or alternatively be stored on a memory device of the computer mouse. The user data may include text documents, images, video files, and audio files.

A launch button of the computer mouse may be activated to display the marketing information on a display skin of the computer mouse, and the marketing information may then be viewed on the display skin. The launch button may be activated by moving a housing of the computer mouse from a first position to a second position. Due to the configuration of the display skin, viewing the marketing information on the display skin may comprise viewing various portions of the marketing information at the front, back, top, and sides of the computer mouse. It is noted that moving a cursor controlled by the computer mouse over a promoter's brand may also cause marketing information from the promoter to be displayed on the display skin. In addition or alternatively, generating a sound recognizable by the computer mouse may cause the mouse to display marketing information on its display skin.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating components of an exemplary interactive computer mouse;

FIG. 2A is a front view of an exemplary interactive computer mouse;

FIG. 2B is a back view of an exemplary interactive computer mouse;

FIG. 2C is a top view of an exemplary interactive computer mouse;

FIG. 2D is a bottom view of an exemplary interactive computer mouse;

FIG. 3A is a front perspective view of an exemplary interactive computer mouse and sensors;

FIG. 3B is a back perspective view of an exemplary interactive computer mouse and sensors;

FIG. 4A is a side view of an exemplary interactive computer mouse and launch button in a first state;

FIG. 4B is a side view of an exemplary interactive computer mouse and launch button is a second state;

FIG. 5A is a front perspective view of an exemplary interactive computer mouse having a display skin;

FIG. 5B is a back view of an exemplary interactive computer mouse having a display skin;

FIG. 5C is a back view of an exemplary interactive computer mouse having a display skin;

FIG. 5D is a top view of an exemplary interactive computer mouse having a display skin;

FIG. 5E is a front perspective view of an exemplary interactive computer mouse having multiple display skins;

FIG. 5F is a top view of an exemplary interactive computer mouse having multiple display skins; and

FIG. 6 is a flow diagram illustration operation of an exemplary interactive computer mouse.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the interactive computer mouse herein provides a number of features which provide “two-way” communication between a user and his or her mouse. In addition, the interactive computer mouse provides unique functionality in response to user inputs as well as various ways of capturing user input that are distinct from that of traditional computer mice.

Traditional computer mice do not take into account the benefit of a computer mouse's location relative to a computer user for two way interaction. Instead, traditional mice are solely directed to capturing a user's movements or clicks to allow the user to navigate a user interface on a computer screen or the like. As will be detailed herein, the interactive computer mouse utilizes its close proximity to a user to provide engaging interactive features.

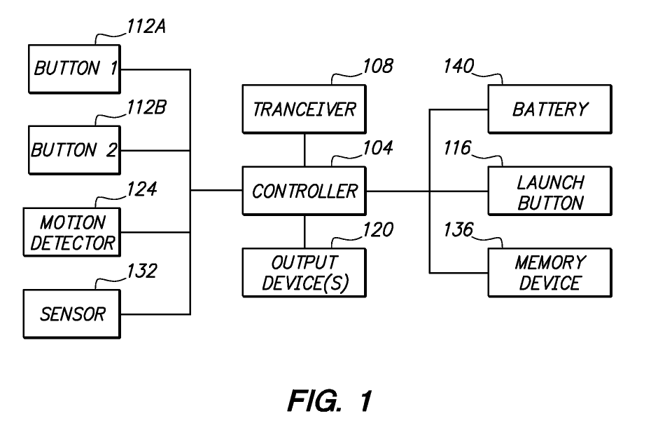

The interactive computer mouse and features and functionality thereof will now be described with regard to FIG. 1. FIG. 1 is a block diagram illustrating a component configuration of an exemplary interactive computer mouse. It is noted that though a particular configuration is shown, variations may be used in different embodiments of the interactive computer mouse.

In one or more embodiments, various components of the interactive computer mouse may be coupled with a controller 104. The controller 104 may be configured to receive various input, process the inputs, and generate output to provide the functionality of the interactive computer mouse described herein. In one or more embodiments, the controller 104 may receive input from and control operation of various components of the interactive computer mouse. In addition to allowing the interactive computer mouse to function as a pointing device, the controller 104 may be configured to communicate information between itself, a user, a host computer, or various combinations thereof. For example, the controller 104 may instruct various output devices of the interactive computer mouse to generate their respective output in response to input received at the components, as will be further described below.

It is noted that the controller 104 may be various circuits, microprocessors, or the like. In addition, one or more controllers 104 may be used to provide the functionality described herein. The controller 104 may execute one or more instructions to perform its functions. The controller 104 may have instructions hardwired into its circuitry. Alternatively or in addition, the controller 104 may read the instructions from a memory device 136. For example, the controller 104 may retrieve machine readable code (containing the instructions), such as firmware or software, from a memory device 136.

The memory device 136 may be integral with the controller 104 or remote from the controller in various embodiments. One or more memory devices 136 may be provided for storing various types of data. For example, the controller's instructions may be stored on a first memory device 136 while other data is stored on another memory device. Alternatively, the controller's instructions may be stored at a remote location and the mouse may download instructions to the local memory device 136, such as through a network. In one embodiment, a memory device 136 may be configured to store a user's data within the interactive computer mouse. In another embodiment, the user's data may be stored by the mouse at a remote location and downloaded to the local memory device 136. For instance, the mouse may comprise a memory device 136 that accepts user data, such as from the user's computer or from a remote computer or server. The memory device 136 may have a variety of configurations. For example, the memory device 136 may comprise magnetic media, optical media, flash media, or other media capable of retrievably storing user data. The data storage provided by the memory device 136 may be temporary in some embodiments. For instance, the memory device 136 may comprise one or more DRAM chips or the like. Once power to the mouse is turned off, the data stored on such temporary memory devices 136 may be lost.

An existing connection (wired or wireless) used to communicate mouse movement and other user input between the mouse and a host computer may be used to transfer user data to and/or from the mouse. Alternatively, a separate connection (wired or wireless) may be made to accomplish such data transfer. It is contemplated that an eSATA, USB, Firewire, Bluetooth, 802.11 or other connection may be used. Such connection(s) may also be used to transmit input and output to and from the mouse to provide the various interactive features described herein. In one or more embodiments, a transceiver 144 may be included to provide the connection between the mouse and a host computer.

In one or more embodiments, the interactive computer mouse may provide functionality like that of a traditional mouse (in addition to its enhanced features and functionality). For instance, the interactive computer mouse may serve as a pointing device having one or more mouse buttons 112 to capture a user's clicks or button presses. Accordingly, the interactive computer mouse may comprise a first mouse button 112 and a second mouse button corresponding to the left and right mouse button. It is contemplated that only one mouse button 112 may be provided in some embodiments, such as in traditional mice having only a single button. The mouse buttons 112 may be contact switches, touch sensitive areas, or similar devices which are capable of registering a mouse click by detecting a user's touch or force at the user inputs. A scroll wheel 128 may be provided in one or more embodiments. The scroll wheel 128 may also be clickable, such as a button, and may also or alternatively tilt in addition to scrolling.

One or more motion detectors 124 may be included as well. The motion detectors 124 may be used to detect movement of the interactive computer mouse. Accordingly, the motion of the interactive computer mouse may be reflected via a pointer or cursor on a host computer's screen. Various devices capable of detecting movement of the interactive computer device may be used as a motion detector 124. For example, a motion detector 124 may comprise a ball and roller mechanism (that detects motion of the mouse by rotation of the ball), a light sensor, a gyroscope, an accelerometer, the like, or various combinations thereof.

As discussed above, the interactive computer mouse includes enhancements that may provide two-way communication between a user and the mouse or the user's computer. This is distinct from traditional mice which typically only accept user input. In addition, this allows the interactive computer mouse to serve as a unique way of communicating information to users. As will be described further below, in this manner, the interactive computer mouse takes advantage of the “connection” between a user and the mouse due to the close proximity of the mouse to the user when in use.

The interactive computer mouse will typically comprise one or more output devices 120 to provide the interactivity described herein. In general, the output devices 120 may be used to present information to a user in various ways. For example, an output device 120 may generate audio, visual, tactile output, or a combination thereof. As will be described further below, an output device 120 may have various configurations, including unique physical configurations. It is contemplated that an output device 132 may be one or more screens, displays, speakers, vibration/sensation generators, image projectors, or the like.

An output device 120 may be controlled, at least in part, by a controller 104. For example, a controller 104 may receive audio and/or visual information for presentation via an output device 120. The controller 104 may communicate this information to the output device 120 in a usable format for presentation on the output device. For example, in one embodiment, visual information may be received and provided to an output device 120 comprising a screen or display via the controller 104. It is noted that a host computer may also control an output device 120 of the mouse directly or in concert with a controller 104 of the mouse.

The host computer and/or controller 104 may process information before it is presented by an output device 120 in some embodiments. For example, visual information may be processed such that it is displayed taking into account one or more curved or other shaped surfaces of a display or screen. In one embodiment, the visual information may be processed to correct distortion from the shape of the display or screen. For example, the visual information at the top of a sphere shaped display may be expanded or enlarged so that it does not appear pinched at the tope of the sphere shaped display.

In one or more embodiments, the interactive computer mouse may also include one or more “smart” buttons the cause particular operations or actions to occur, referred to herein as launch buttons 116. A launch button 116 will typically be preset to, upon activation/engagement, cause one or more predefined operations at a host computer, the interactive computer mouse, or both to occur. As will be discussed below, the predetermined operation will typically not be alterable by a user once set by the mouse's manufacturer, distributor, seller or other provider. A launch button 116 may also have a unique physical configuration (in comparison with traditional mouse buttons) as will be described further below.

The launch button 116 may be a variety of inputs including a physical button, touch button, switch, sensor, accelerometer or the like that detects user input and causes at least one predefined operation to occur when activated or engaged. For example, a button may detect a user's touch or click. In another embodiment, a launch button 116 comprising an accelerometer may detect sudden or intermittent motion of the interactive computer mouse. For example, the accelerometer may detect when and/or where a user is tapping on a mouse, such as with one (or more) of the user's fingers.

The launch button 116 may be located at various locations. For example, the launch button 116 may be adjacent one or more of the mouse buttons at the top or front of the mouse. The launch button 116 may be in front of, behind, or be positioned laterally relative to a scroll wheel or middle mouse button in some embodiments. Alternatively, a launch button 116 may be at a back portion of the mouse, such as a portion of the mouse opposite the one or more mouse buttons, or a portion of the mouse adjacent or in contact with the user's palm when in use.

It is contemplated that the interactive computer mouse may also comprise one or more sensors 132 that collect input from a user and/or from the environment around the interactive computer mouse. A sensor 132 may collect various types of input and thus may have a variety of configurations. For example, a sensor 132 may be a microphone, camera, light sensor, proximity sensor, temperature sensor, touch sensor, or the like.

In some embodiments, the interactive computer mouse may include a power source 140, such as a battery, to power one or more of its components. For example, in a wireless embodiment, the power source 140 may be the primary source of electricity for the mouse. It is contemplated that the power source 140 may be present in wired embodiments as well, such as to power one or more interactive features when power from a host computer is not available. For instance, when the host computer is turned off or in sleep mode, the power source 140 may continue to power one or more interactive features of the mouse. These features may make use of various components of the mouse. For example, one or more output devices 120, sensors 132, launch buttons 116, or other components may be powered to provide an interactive feature even when the host computer is off, in sleep mode, or is otherwise inactive.

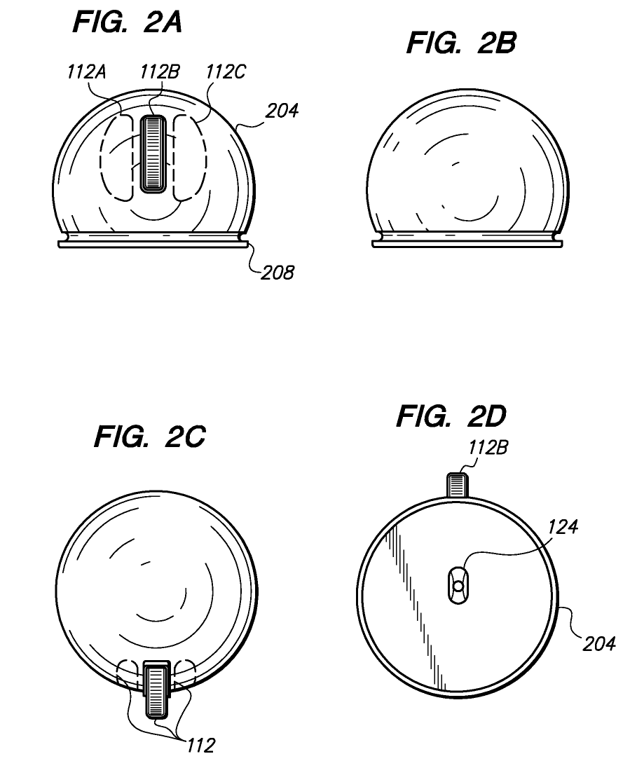

Additional details regarding the interactive computer mouse will now be described with regard to FIGS. 2A-2D. FIGS. 2A-2D illustrate views of an exemplary interactive computer mouse. More specifically, FIGS. 2A-2B respectively illustrate a front and back view of the computer mouse, while FIGS. 2C-2D respectively illustrate a top and bottom view of the computer mouse.

As can be seen from FIGS. 2A and 2C, the interactive computer mouse may have a first button 112A, a second button 112C, and a scroll wheel button 112B (that may alternatively be a scroll wheel only). The buttons 112A,112C and scroll wheel button 112B may be at the front of the mouse, such as shown, to allow them to be easily accessible when the user places his or her hand on the mouse. The buttons 112A,112C have been shown in broken lines to indicate that the buttons may be areas of the mouse (such as its housing 204) at which the mouse may detect a user's touch or force to “click” the buttons. Alternatively, the buttons 112A,112C may comprise physical buttons that have a “clickable” portion on the surface of the housing 204. It is noted that the mouse may have various numbers of buttons as discussed above.

The interactive computer mouse may comprise a housing 204 or enclosure in one or more embodiments. In general, the housing 204 supports and/or encloses the components of the mouse, such as the components discussed above with regard to FIG. 1. Though shown in a particular configuration, it is noted that the housing 204 may have a variety of configurations. For example, the housing 204 may have various shapes and sizes in addition to the spherical shape illustrated in FIGS. 2A-2D. To illustrate, the housing 204 may have a cube or rectangular shape, a polygonal shape, various ergonomic shapes, a curved shape, various combinations thereof, or the like. The housing 204 may be configured (e.g., sized and/or shaped) to support advertising or other marketing information thereon. For instance, the housing 204 may have advertising printed thereon.

It is noted that the buttons 112A,112B and scroll wheel button 112C may have various shapes and sizes as well. In addition, though these buttons 112A,112B,112C will typically be at the front of the mouse, they may be positioned at various locations at the front of the mouse in such embodiments.

In some embodiments, the interactive computer mouse may also include a base 208 at its bottom end or portion. The base 208 may provide a structure which contacts a user's desk, mouse pad, or other surface upon which the mouse may be used. In addition, the base 208 may support the housing 204 and other components of the mouse. For example, as can be seen, the base 204 shown supports the motion detector 124 (See FIG. 2D) as well as the housing (See FIG. 2A). As shown, the motion detector 124 comprises an optical motion detector, however, various other motion detectors 124 may be used as discussed above.

As can be seen, a substantial portion of the housing 204 is unoccupied by buttons 112A,112B,112C Likewise, traditional mouse having traditional buttons also have a substantial area of housing that is unoccupied. Traditionally, manufacturers have used this area to print their corporate trademarks. In some cases, such as in wireless mice, a small portion of this area is used for one or more LED indicators. Typically, these indicators are used as battery life indicators.

Thus, traditional computer mice have failed to take advantage of an opportunity to provide interactive features. This is because manufacturers have incorrectly assumed that, because a mouse will be covered by a user's hand during use, interactivity (comprising input and output of information) at the mouse is severely limited. However, as will become apparent from the disclosure herein, the limitation is relatively minor as a mouse may uncovered for a substantial period of time even during use (e.g., when the user is typing). In addition, where interactive features are provided at a mouse, the user will be enticed and more likely to uncover at least a portion of the mouse to participate in the interactive feature being presented by the mouse, if only for a moment. Such presentation of information is highly advantageous given the close proximity of computer mice to their users and the heavy usage that computer mice undergo.

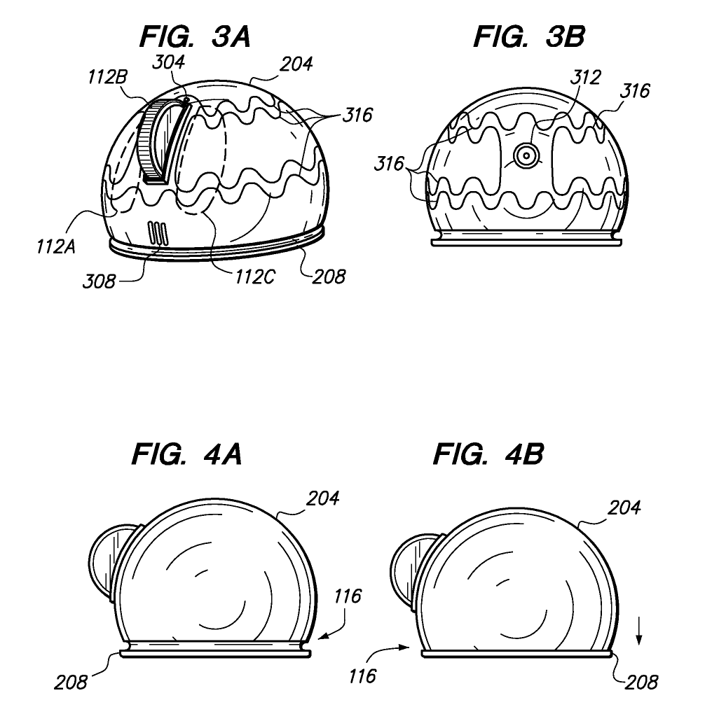

That said, additional features of the interactive computer mouse will now be described with regard to FIGS. 3A-3B. FIG. 3A illustrates a front perspective view of an exemplary interactive computer mouse having a sensor in the form of a microphone 304 for collecting sound from the user or surrounding environment. As can be seen, the mouse may also or alternatively comprise an output device in the form of a speaker 308 to generate sound output and/or haptic feedback. One or more openings may be in the housing 204 to allow sound to easily move through the housing to/from an internally mounted speaker 308 and/or microphone 304. For example, a microphone 304 or a speaker 308 may be at the back or other portion of the mouse in some embodiments. FIG. 3B provides a back perspective view of the interactive computer mouse. As can be seen, the mouse may comprise a sensor in the form of a light sensor or camera 312. These may be used to detect changes in light levels and/or capture images from the mouse's perspective. It is noted that various sensors, output devices, and other mouse components, such as those described herein, may be located at various areas of the housing 204 or base 208 of the mouse.

In addition or alternatively, as shown in FIG. 3A-3B, the interactive computer mouse may comprise one or more touch sensors 316. The touch sensors 316 may be used to determine whether or not the user is in contact with the mouse, where the user is contacting the mouse, or both. Though shown in particular configurations, it is noted that a touch sensor 316 may be at various locations of the mouse, such as its housing 204 or base 208, and may have various shapes and sizes depending on what areas of the mouse are to be touch enabled. It is also noted that one or more touch sensors 316 may be beneath the surface of the housing 204 and still function properly. For instance a change in light level, a user's touch, or other input may be detected through the housing 204 in one or more embodiments.

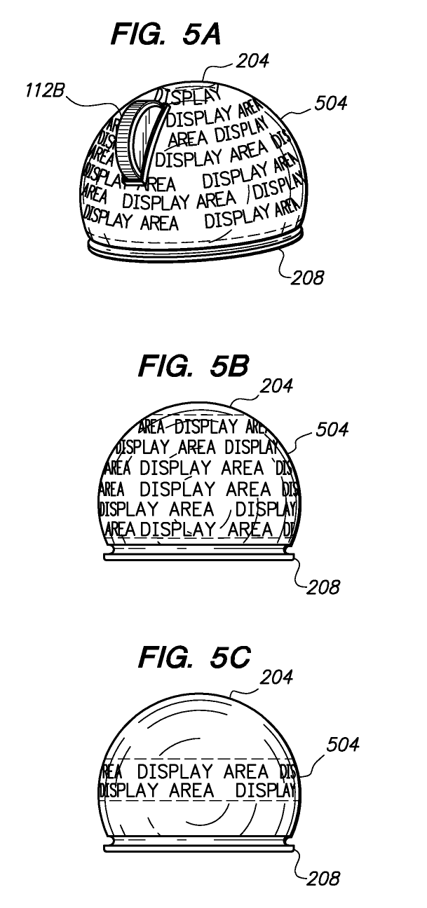

FIGS. 4A-4B illustrate a side view of an exemplary interactive computer mouse having a launch button 116. As shown, the launch button 116 allows the housing 204 to be moved relative to the base 208. The launch button 116 may be activated or engaged by pressing the housing 204 towards the base 208 in one or more embodiments. The user may utilize his or her palm to accomplish this rather than his or her fingers (such as with traditional mouse buttons).

FIG. 4A illustrates the launch button 116 in a non-engaged state. As can be seen, the housing 204 is a first distance away from the base 208 in this configuration. FIG. 4B illustrates the launch button 116 in an engaged or activated state. As can be seen, the housing 204 is now a second distance away form the base 208. As shown, the second distance is one that is closer to the base 208 than the first distance. The launch button 116 may comprise a switch that is engaged as the housing 204 is moved relative to the base 208. Activating the launch button 116 may produce a particular preset output from the mouse and/or its host computer as will be discussed further below. It is noted that multiple launch buttons 116 may be provided if desired. Each launch button may cause a different preset output to occur.

Typically, a launch button 116 will have physical characteristics which distinguish it from a typical mouse button, such as the traditional left button, right button, and/or scroll wheel found on typical mice. For instance, it can be seen from

FIGS. 4A-4B that the launch button 116 is physically distinct from traditional buttons. As stated, the entire housing becomes the launch button 116 in this embodiment. The user may activate the button by pressing down with his or her palm. In addition, the launch button 116 is more enticing to press since a user may slap or smack the launch button like a game show buzzer.

It is contemplated that a switch for the launch button 116 may be at various locations. For example, the switch may be between the housing 204 and the base 208 in one or more embodiments. Alternatively or in addition, the switch may be at the top or bottom sides of the base 208.

A launch button 116 need not be configured as shown in FIGS. 4A-4B. For example, in some embodiments, the launch “button” 116 may not even be a button or switch type input. The launch button 116 may be a sensor for instance that is configured to recognize certain events. For example, the launch button 116 may be a light sensor, audio or video recognition device, accelerometer, gyroscope, temperature sensor, proximity detector, or other sensor. In such configurations, the launch button 116 may be activated by the recognition of particular sounds, images, temperatures, movements, proximities, light levels, and the like. To illustrate, in one embodiment, the launch “button” 116 may be activated by speaking or yelling one or more particular words or by generating particular sounds or sounds of a particular loudness. In another example, the launch “button” 116 may be activated by shaking the mouse, squeezing the mouse, staring at the mouse, touching the mouse in a particular way, or various combinations thereof. It is contemplated that each type of launch “button” activation may cause a different preset output to occur.

It is also contemplated that the processing required to recognize activations may be offloaded to the host computer. For example, sensor input received by the mouse may be transmitted to the host computer for processing. Any recognized activation events may then be communicated back to the mouse, thus causing a preset output to occur. Recognition may also or alternatively be performed by one or more of the mouse's components, such as its controller.

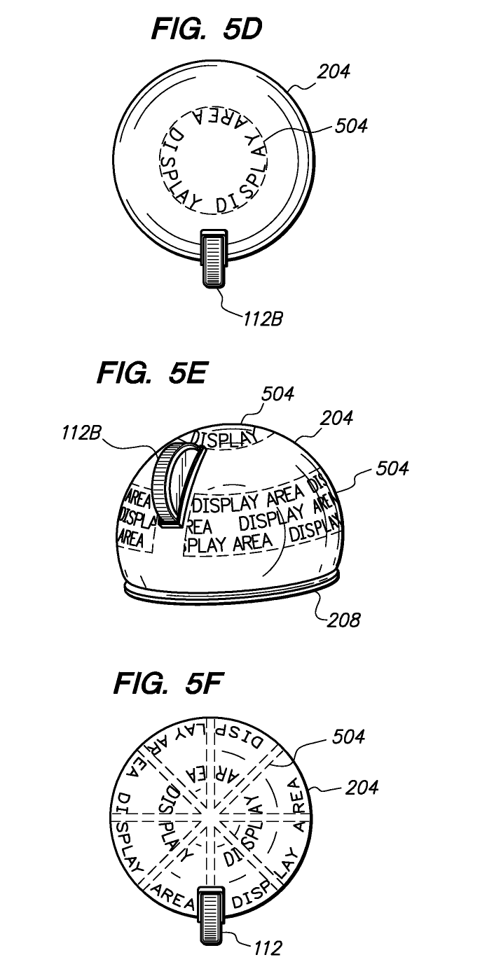

Additional interactive features will now be described with regard to FIGS. 5A-5E. FIGS. 5A-5E provide various views of an interactive computer mouse having an output in the form of one or more display skins 504. A display skin 504 may comprise various components. For example, a display skin 504 may include a LCD, OLED, E-Ink or other screen or display. It is contemplated that an array of LEDs or other light emitters may also form the display skin 504. The display skin 504 may also or alternatively utilize pixels to present information or segmented character displays to present information. The display skin 504 may be black and white, grayscale, have one or more colors, or a combination thereof. Static text, characters, images, or the like may be presented by the display skin 504. In addition, one or more videos or animations may also or alternatively be presented by the display skin 504.

As illustrated in FIGS. 5A-5E, the display skin 504 is referred to as such because the display skin will typically conform to the shape of the housing 204 or form the shape of the interactive computer mouse in one or more embodiments. Alternatively, the display skin 504 may form the housing 204 or a portion of the housing. In this manner, the interactive computer mouse may retain its shape, even when its shape includes one or more curves, angles, or other decorative or ergonomic designs. This permits the mouse to be used without the display skin 504 protruding into a user's hand. It is contemplated that the display technology used may one that may be formed to conform to the shape of the mouse. For example, an OLED, EINK, or array of LEDs may be used to form a display skin 504 with one or more curves, angles or the like that conform to the shape of the mouse.

FIGS. 5A-5E illustrate various configurations of display skins 504. Though shown in these configurations, it is noted that a display skin 504 may be various shapes and sizes. In addition, a display skin 504 may be at various locations of the housing 204. The display skin 504 may extend into or over the areas where buttons 112 are located. For example, a touch sensitive button 112 may be covered by the display skin 504 and still be “clickable” by the user. Alternatively or in addition, the button 112 may comprise a display skin 504 at its surface, or the display skin may be flexible so as to allow the button to be pressed through the display skin.

FIGS. 5A-5B illustrate exemplary display skins 504 that may be used with the interactive computer mouse. FIG. 5A shows a front perspective view while FIG. 5B shows a rear or back view. As shown, the display skin 504 has a large surface area that forms the housing 204 of the mouse. Alternatively, in other embodiments, the display skin 504 may cover or form some, most, or all of the housing 204. For example, in one embodiment, the display skin 504 may cover or form at least 30% of the housing's external surface. In another embodiment, the display skin 504 may form at least 50% or at least 70% of the housing's external surface. Also, it is noted that the display skin 504 may cover or form only a portion of the housing 204 in some embodiments.

As can be seen, the display skin 504 of this configuration allows information to be presented virtually anywhere on the interactive computer mouse. In this manner, the information may be viewable from virtually any angle. In addition, information may be presented at any location on the mouse in such embodiments. In one embodiment, a single continuous display skin 504 may form most or all of the housing. In another embodiment, multiple display skins 504 may be joined to form most or all of the housing.

As stated above, the display skin 504 may only cover or form a portion of the housing 204. To illustrate, FIG. 5C shows a display skin 504 that comprises a band around the interactive computer mouse. FIG. 5D illustrates another exemplary embodiment of a display skin 504. As can be seen, the display skin 504 may be at the top of the mouse. In FIG. 5D for example, the display skin 504 appears to “cap” the mouse. Though shown extending for a particular portion of the mouse body, it is noted that the display skin 504 may extend to form or cover more of the mouse if desired.

In some embodiments, the interactive computer mouse may comprise multiple display skins 504. To illustrate, FIG. 5E shows a mouse having a first display skin 504 at the top of the mouse and a second display skin around the body of the mouse. Other configurations are possible as well. For example, the “band” around the mouse could be formed by a series of multiple separate display skins 504 of the same or various shapes. Alternatively or in addition, multiple display skins could be arranged at various locations of the mouse. These display skins 504 may have various shapes and sizes. In one embodiment, the display skins 504 may substantially cover the mouse with a relatively small area of housing 204 between each of the display skins.

To illustrate, FIG. 5F shows an exemplary mouse having a close arrangement of display skins 504. As can also be seen, the display skins 504 have a variety of shapes (as discussed above). In FIG. 5F for instance the display skins 504 have wedge-like shapes that, in combination, cover or form a substantial portion of the housing 204. Other shapes are possible as well. For example, a display skin 504 may have one or more straight edges, curves, angles, or the like.

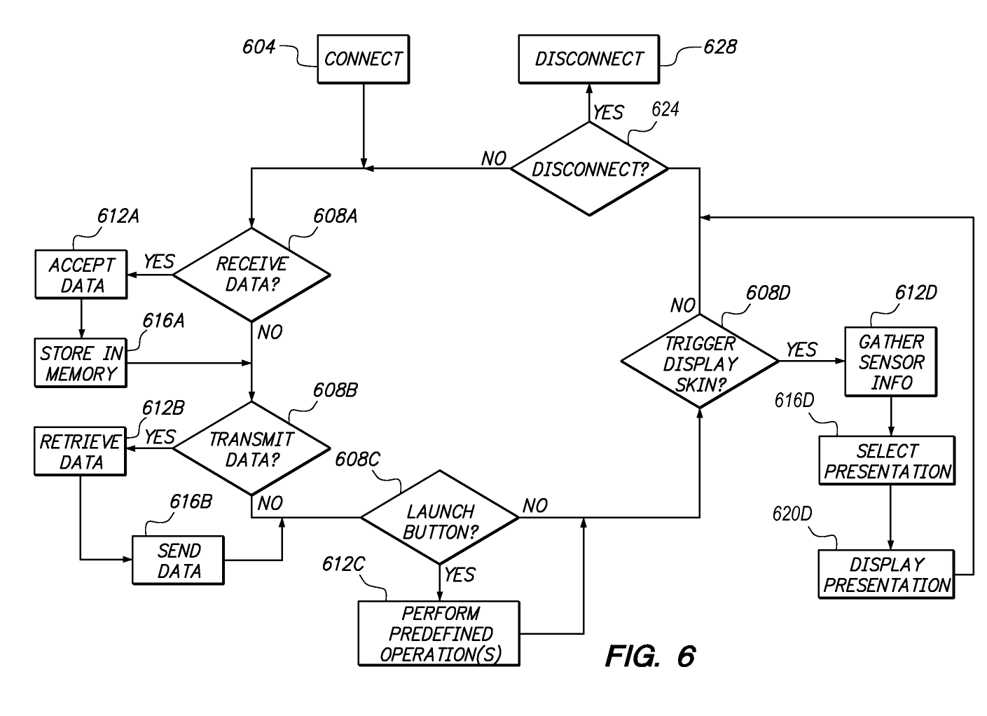

Operation of the interactive computer mouse will now be described with regard to FIG. 6. FIG. 6 is a flow diagram illustrating some exemplary interactive features 608 that the interactive computer mouse may provide. Namely, a data receiving feature 608A, data transmitting feature 608B, launch button feature 608C, and display skin feature 608D have been illustrated in FIG. 6. It is noted that various combinations of the interactive features 608 may be provided in some embodiments. In other embodiments, only a single interactive feature 608 may be provided.

As can be seen, the interactive computer mouse may provide interactive features 608 after it is connected or plugged in to a host computer at a step 604 and before it is disconnected at a step 628. It is contemplated that the connection and disconnection may be made through a wired or a wireless connection. In embodiments, where the mouse remains powered (e.g., battery powered embodiments) even when its host computer is off, in sleep mode, or otherwise inactive, it is contemplated that the mouse may provide interactive features 608 regardless of whether it is connected or in communication with a host computer.

FIG. 6 illustrates a loop for providing the interactive features 608. It is noted that the loop may run any number of times and as such, each interactive feature 608 may be provided one or more times, if desired. Though the interactive features 608 executed by the loop have been presented in a particular arrangement, it is noted that the interactive features may be in various orders or arrangements. In addition, it is noted that the interactive features 608 need not be run in a loop such as shown. For instance, each interactive feature 608 may be directly requested and provided as a result of the request. For example, an input indicating that an interactive feature 608 is requested may cause such feature to be executed. For example, activating the launch button of a mouse may cause the interactive feature 608C associated with the activation of such launch button to be executed or otherwise provided.

Once connected at step 604, the interactive computer mouse may provide a data receiving feature beginning at a decision step 608A. At decision step 608A, if data is being sent to the mouse for storage, such as by a host computer, the data may be accepted at a step 612A and stored at a step 616A. If not, the mouse may continue back to the loop and provide one or more other interactive features if desired.

The data may be stored on a memory device of the mouse. It is noted that accepting the data at step 612A may include verifying that the data is authorized for storage on the mouse. For example, the data may need to have a proper electronic signature and/or a valid username/password may need to be provided before the data may be accepted for storage at the mouse. In some embodiments, this may be optional and, as such, all data that is received for storage on the mouse may be stored on its storage device.

It is noted that data on the mouse may be synchronized with data on a host computer. In such embodiments, the host computer may automatically and/or periodically store (or modify) data on the mouse to ensure that the data on the mouse is the same as that on the host computer. In one embodiment, the synchronization occurs automatically, such as when or after the mouse is connected at step 604 or when data on the host computer is created, modified, or deleted. The synchronization may be started by a user as well, such as by clicking a button or launch button of the mouse. It is contemplated that the user may specify which directories, files, or both that should be synchronized.

The interactive computer mouse may provide a data transmit feature beginning at a decision step 608B. At decision step 608B, if data has been requested for transmission from the mouse, the data may be retrieved from a memory device of the mouse at a step 612B. If not, the mouse may continue back to the loop and provide one or more other interactive features if desired. The retrieved data may then be transmitted to the host computer at a step 616B.

Data may be requested for transmission from the interactive computer mouse in various ways. For instance, data may be transmitted in response to a request for such data from a host computer. In addition, data may be transmitted from the mouse to synchronize data on the mouse with data on the host computer. As discussed above, such synchronization may occur at a user's request, automatically, periodically, or as the result of various triggering events. It is noted that the user may specify whether data on the mouse should take precedence over data on the host computer, or vice versa.

At a decision step 608C, if a launch button is activated (e.g., clicked, touched, pressed, etc . . . ), one or more predefined operations may be performed at a step 612C. For example, referring to FIGS. 4A-4B, in one embodiment, the entire housing 204 may be pressed down to activate a launch button 116. As stated, the launch button 116 causes one or more predefined operations or instructions to be executed.

Though a variety of operations may be configured by a manufacturer, distributor, merchant, promoter, or the like, these operations may not be changed by an end-user in one or more embodiments. For example, the operations may be protected by one or more tamper prevention mechanisms. For example, the operations may be hardwired into the processor or other component of the interactive computer mouse. Alternatively or in addition, one or more signing/verification algorithms may be used to ensure the instructions are not altered. The mouse may be configured to deactivate itself if an alteration in the instructions is detected. The deactivation may be temporary (e.g., until the instructions are restored to their unaltered state) or may be permanent (e.g., can not be reversed). For example, a ROM containing operations required for the mouse to operate may be temporarily or permanently disabled. In one embodiment, a deactivation indicator may be written to a write-once memory device to disable the mouse.

A variety of predefined operations may be provided in or with the interactive computer mouse. Typically, the operations will be configured to present marketing information, such as one or more promotions or advertisements. The marketing information may comprise text, characters, graphics, images, photos, videos, animations, audio, the like, or various combinations thereof. In one or more embodiments, the marketing information may comprise a promoter's or brand's text and/or logo. The marketing information may be one or more websites, web pages, or other electronic documents. Alternatively or in addition, the name, image, graphic, or other representation of a good or service may be part of the marking information. It is contemplated that text, such as ad copy may also be part of the marketing information. In one or more embodiments, the marketing information may include distinct sets of information for one or more individual brands, goods, services, or combinations thereof.

Some examples of marketing information include coupons, discounts, and other offers or promotions where a user may save money on purchases. The marketing information may come from a variety of merchants, distributors, and other promoters. The quality (i.e., how much money is saved) of a promotion may be based on when the user activates the launch button. For example, higher discounts or better offers may be provided at random or predetermined times of day. This encourages the user to activate the launch button repeatedly. The user may not take part in all the promotions displayed as a result of activating the launch button. However, the interactive mouse's provider benefits from the user seeing its promotion(s).

As discussed above, the launch button may be formed by the entire or a substantial portion of the interactive computer mouse's housing. This makes the launch button easy to activate. In addition, the large size of the launch button may entice users to press it in that it is analogous to a large game show buzzer that people may enjoy smacking or slapping to activate. It is noted that the shape of the housing may be configured to enhance this characteristic. For example, the housing may have a mushroom shape or a flattened shape like that of a large buzzer or button.

During the user's leisure time, he or she may be tempted to activate the launch button for fun. In addition, the user may activate the launch button for a momentary distraction provided by the provider's marketing information.

The marketing information may be in multiple colors, shades of grey, two colors (e.g., black and white). This is because the marketing information may be displayed with various display technologies with various color reproduction capabilities. For example, in addition to presenting marketing information (or a portion thereof) on a display skin of the interactive computer mouse, the marketing information may be displayed on a screen, such as a CRT, LCD, LED, DLP, projection, EINK, or OLED screen attached to the host computer. In addition, as stated the display skin may itself be a variety of display technologies having multi-color, two-color, or grayscale display capabilities.

It is contemplated that the marketing information's color or lack thereof may be determined based on the display the marketing information is to be displayed on. In one or more embodiments, the interactive computer mouse may comprise a converter that converts color or other marketing information to a format suited for the mouse's display skin. For example, marketing information could be converted to a two-color (e.g., black and white) or grayscale representation for presentation on an EINK display skin.

The marketing information may be stored on a memory device of the interactive computer mouse in one or more embodiments. Alternatively or in addition, the marketing information may be stored on the host computer. For example, one or more web addresses, documents, images, sounds, videos, animations, or other data may be stored on the mouse or the host computer for retrieval and presentation, such as after the launch button is pressed. The marketing information need not be static, and may be downloaded or updated from a remote source, such as a web or other server. The manufacturer, distributor, or other provider of the mouse may specify the contents of the marketing information.

The marketing information may be displayed on display of a host computer. For instance, activating the launch button may cause marketing information to be displayed on the host computer's display. In one embodiment, the marketing information may be in a window or panel of the host computer's user interface. It is contemplated that the marketing information may be a webpage/website address, video, image, animation, text window that appears on the host computer's display when the launch button is activated. In one or more embodiments, the launch button's operations may not be altered by a user (as discussed above).

Alternatively or in addition, the marketing information may be presented on the display skin of an interactive computer mouse. For instance, in one or more embodiments, activating the launch button may cause marketing information to be presented on the display skin It is contemplated that the marketing information may be configured to occupy most or all of the display skin in one or more embodiments. Since the display skin may form the housing of the mouse in some embodiments, the marketing information may be displayed throughout the mouse's housing. This provides an engaging graphical display and allows the marketing information (or various portions thereof) to be viewed regardless of where the user is located relative to the mouse.

It is noted that marketing information may be presented through other output devices of the interactive computer mouse and/or host computer. For example, the mouse may comprise a speaker which may be used to output audible marketing information such as one or more spoken or vocal advertisements or other sounds. The audio (or other) presentation of marketing information may take place in addition to or instead of the presentation of marketing information of the display skin or a display of a host computer.

Marketing information on a host computer's display may be presented in concert with marketing information on the interactive computer mouse. For example, portions of marketing information may be on the host computer's display while other portions may be on the display skin. The portions may interrelate in one or more embodiments. For example, one portion on the display skin may direct the user to refer to the host computer display, and vice versa. To illustrate, in one embodiment, a promotion, such as ad copy may be presented on the host computer's display, while the discount, savings, or other specific details for the promotion may be presented on the display skin. Text or other indicators may be used to instruct the user to check the mouse for the actual amount of savings, discounts, or other details.

It is contemplated that a user may interact with the marketing information via the host computer's display, the display skin, or both. For example, as discussed above with regard to FIGS. 3A-3B, one or more touch sensors 316 may be beneath the display skin. In this manner, the user may touch elements of the marketing information. In response, additional details may be displayed or the marketing information may be changed. For example, a user may find out more about a promotion by touching elements of the promotion, such as the terms and conditions, expiration date, etc . . . A user may also move through a selection of promotions, such as by touching a “Next” button or the like presented on the display skin.

The user's touch inputs may be transmitted to the host computer in some embodiments. Marketing information displayed on the host computer may then react to the touch input as well. For example, moving to another promotion may cause marketing information related to the newly displayed promotion to be presented on the host computer. Alternatively or in addition, marketing information that is not readily displayable on the display skin may be presented on the host computer. For example, some display skins may not be ideal for displaying full color or animated marketing information. Accordingly, though it may be possible to display such marketing information on the display skin, the marketing information may be selected for display on the host computer instead to give the user a better viewing experience.

In one or more embodiments, the launch button may be activated in various ways. For example, the launch button may be “double-clicked” or held down for a period before being released. The particular marketing information displayed may be selected based on how the launch button is activated. For example, a double-click may cause a first marketing information to be displayed, while a “normal” activation (such as described above) may cause different marketing information to be displayed. Holding the launch button may cause another response. For example, a rotating or other moving selection of promotions and a pointer or other indicator may be displayed while the launch button is being held. When the launch button is released, the promotion adjacent the pointer may be displayed. It is noted that other animations could be displayed while the launch button is being held. For example, a rapid progression of symbols or images could be displayed while the launch button is being held.

Once one or more of the above operations resulting form the activation of the launch button are completed at step 612C, the interactive computer mouse may return to the loop (such as that shown in FIG. 6). At a decision step 608D, if a triggering event has occurred, a presentation may be displayed on the display skin A presentation may be various graphics including images and text, or various videos or animations. Marketing information may be a presentation in one or more embodiments, but it is noted that a presentation need not promote goods or services. For instance, a presentation may inform or communicate various other information with a user, as will be illustrated below. Audio from a speaker of the mouse may be part of a presentation in some embodiments.

A triggering event or trigger may be a variety of occurrences. It is contemplated that the presentation on the display skin may “react” to the user's manipulation (e.g., movement) of the mouse. For example, moving the cursor over certain types of screen elements may cause the presentation on the display skin to change. To illustrate, moving the cursor over a hyperlink, icon, window, button, or other screen element may cause the presentation on the display skin to be changed.

In some embodiments, the interactive computer mouse may be configured such that the presentation on the display skin changes when the cursor is over particular screen elements. For example, the presentation may change only when the cursor is over a particular company's brand, goods, or services. The mouse's driver may provide a facility to recognize where the cursor is on the screen and/or what the cursor is over. In this manner, the cursor's current position may trigger changes on the display skin.

In other embodiments, input from various of the interactive computer mouse's sensors may be used to trigger presentations on the display skin. For example, a lower light level may cause a first presentation to be displayed on the display skin, while a higher light level may cause a different presentation, or vice versa. As another example, different presentations may be displayed as the result of one or more sounds or images, such as may be respectively captured by a microphone or camera of the mouse. Different presentations may also be provided in response to one or more particular temperatures or a change in temperature, such as may be detected by a thermometer or other temperature sensor. A proximity sensor may be used to detect the distance of one or more objects or the user from the mouse. The presentation may be varied based on such proximity In addition, movement of the mouse may cause different presentations to be displayed as well. It is contemplated that the activation of a launch button may also cause one or more presentations to be displayed on the display skin.

If a triggering event has occurred at decision step 608D, input from one or more sensors may be processed or analyzed at a step 612D. For example, video or images may be processed to determine light levels, recognize faces, recognize objects, or recognize other triggering events. Voice or sound recognition may be accomplished by processing an audio stream from a microphone of the mouse. If the sensor input is usable without processing step 612D may not take place. For example, temperature readings from a temperature sensor may not need to be processed prior to use because the readings may directly convey the temperature.

At a step 616D, the sensor input may be used to select one or more presentations for display. For example, one or more presentations may be associated with a particular light level or range of light levels on a memory device. The associated presentations may then be retrieved based on the light level. As another example, recognition of a person or object may cause one or more particular presentations to be retrieved. These presentations may have been associated with such person or object in the memory device such that the associated presentations may be retrieved when a particular person or object are recognized.

Once selected, the presentation(s) may be displayed on the display skin at a step 620D. Some example presentations include displaying a person's name when such person's image is recognized. In addition or alternatively a customizable presentation may be displayed. For instance, the user may set up preferred information to be displayed in a presentation (e.g., weather, stock, news, etc . . . ).

When the user is recognized, such customized presentation may be displayed on the display skin. It is noted that such presentations may be displayed upon recognition of a particular user by various user identification techniques.

Additional presentations include the time of day, temperature, various greetings and message, images, a preset stock ticker, horoscopes, words of the day, and the like. It is contemplated that instructions may be presented as well. For example, a presentation may indicate which of the interactive computer mouse's buttons to press to operate a software program or the like. The presentation may also or alternatively indicate which direction to move the mouse (such as by one or more arrows on the display skin). The presentation may also include information regarding the interactive computer mouse. For example, storage utilization on a memory device and/or battery life of the mouse may be presented in some embodiments. It is contemplated that a user may customize what information is displayed in a presentation, except in some cases where the presentation includes a provider's marketing information.

In some embodiments, a presentation may not utilize a display skin For example, another output device such as a speaker of the interactive computer mouse could be used to output an audio presentation. This is beneficial in cases where a speaker is provided and/or where the mouse does not have a display skin.

At a decision step 624, it may be determined if the interactive computer mouse should be disconnected. If so, the mouse may be disconnected, such as from its host computer, at a step 628. Typically, the mouse will no longer be able to communicate with the host computer once disconnected. Disconnection may occur by stopping wireless communications, turning off wired or wireless communications devices, physically disconnecting the mouse from a host computer, or the like. Data stored on the mouse prior to disconnection at step 628 may remain on the mouse. The disconnection step 628 may include completing any data transfers to/from the mouse before communication with the mouse is stopped. The disconnection step 628 may also include storing information on the mouse or transferring settings or configuration information between the mouse and the host computer. If the mouse is not disconnected at decision step 624, the mouse may continue to provide one or more interactive features, as can be seen from FIG. 6.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An interactive computer mouse for displaying marketing information comprising:
a housing, the housing being sized to display marketing information thereon;
one or more mouse buttons configured to capture one or more user inputs;
at least one motion sensor configured to detect motion of the pointing device;
one or more memory devices configured to store one or more web site addresses;
a controller configured to communicate with a host computer and the one or more memory devices; and
a launch button configured to signal the controller to direct a web browser on the host computer to display at least one of the one or more web site addresses when activated.

2. The interactive computer mouse of claim 1, wherein the launch button comprises an accelerometer configured to detect one or more taps on the housing, the launch button being activated upon detecting the one or more taps.

3. The pointing device of claim 7, wherein the launch button comprises the housing and one or more actuating mechanisms located at the base, the launch button configured to move between a first position where the housing is a first distance from the base and a second position where the housing is a second distance from the base.

4. The interactive computer mouse of claim 1, wherein the launch button is located adjacent the one or more mouse buttons.

5. The interactive computer mouse of claim 1 further comprising a speaker configured to output vocal marketing information when the launch button is activated.

6. The interactive computer mouse of claim 1 further comprising:
one or more memory devices are contained within the housing, the one or more memory devices configured to store user data selected from the group consisting of text documents, images, video files, and audio files; and
a transceiver configured to receive the user data for storage on the one or more memory devices and to transmit the user data to a host computer.

7. An interactive computer mouse for displaying marketing information comprising:
a housing comprising a shape having one or more curves, the housing comprising a display skin configured to conform to the shape of the interactive computer mouse and to display information visually on the housing;
a controller configured to receive the marketing information and display the marketing information on the display skin;
one or more mouse buttons configured to capture one or more user inputs; and
at least one motion sensor configured to detect motion of the pointing device.

8. The pointing device of claim 7, wherein the housing contains a launch button configured to signal the controller to display the marketing information on the display skin;

9. The pointing device of claim 7, wherein the display skin forms at least 30% of the housing's exterior surface.

10. The pointing device of claim 9, wherein the housing comprises at least two display skins.

11. The pointing device of claim 7 further comprising a memory device having the marketing information from the promoter fixed thereon, wherein the controller receives the marketing information from the memory device.

12. The pointing device of claim 7, wherein the marketing information comprises a promotion selected from the group consisting of advertising for the promoter's brand, one or more goods offered by the promoter, and one or more services offered by the promoter.

13. The interactive computer mouse of claim 7, wherein the launch button comprises an accelerometer configured to detect one or more taps on the housing, the launch button being activated upon detecting the one or more taps.

14. The pointing device of claim 7, wherein the launch button comprises the housing and one or more actuating mechanisms located at the base, the launch button configured to move between a first position where the housing is a first distance from the base and a second position where the housing is a second distance from the base.

15. The pointing device of claim 14, wherein holding the launch button in the second position for a first period of time signals the controller to display a first subset of the marketing information on the display skin, and holding the launch button in the second position for a second period of time signals the controller to display a second randomly selected subset of the marketing information.

16. A method for presenting one or more interactive features on a computer mouse comprising:
connecting the computer mouse to a host computer;
moving the computer mouse and pressing one or more mouse buttons to control the host computer;
accepting marketing information from one or more promoters;
storing the marketing information on one or more storage devices;
activating a launch button of the computer mouse to display the marketing information on a display skin of the computer mouse;
viewing the marketing information on the display skin.

17. The method of claim 16, wherein activating the launch button comprises moving a housing of the computer mouse from a first position to a second position.

18. The method of claim 16, wherein viewing the marketing information on the display skin comprises viewing various portions of the marketing information at the front, back, top, and sides of the computer mouse.

19. The method of claim 16 further comprising storing user data on a memory device of the computer mouse, the user data selected from the group consisting of text documents, images, video files, and audio files.

20. The method of claim 16 further comprising moving a cursor controlled by the computer mouse over a promoter's brand to display marketing information from the promoter on the display skin.

21. The method of claim 16 further comprising generating a sound recognizable by the computer mouse to display marketing information on the display skin.
